(19) United States
(12) Patent Application Publication
(10) Pub. No.: US 2017/0084216 A1
(43) Pub. Date: Mar. 23, 2017

(54) LOW-POWER DISPLAY METHOD BY SENSING AMBIENT LIGHT AND ASSOCIATED DEVICE

(71) Applicant: MediaTek Inc., Hsin-Chu (TW)

(72) Inventor: Chih-Hsiang HSIAO, Taipei City (TW)

(21) Appl. No.: 14/862,578

(22) Filed: Sep. 23, 2015

(51) Int. Cl. G09G 3/20

(52) U.S. Cl. CPC G09G 3/2003; G09G 2320/0626; G09G 2330/021; G09G 2340/0407; G09G 2360/144

(57) ABSTRACT

A portable device and associated computer-implemented method are provided. The method includes the steps of: utilizing an ambient light sensor of the portable device to detect ambient light around the portable device to generate a first sensing signal; determining whether the first sensing signal is smaller than a first threshold; when it is determined that the first sensing signal is smaller than the first threshold, controlling a display panel of the portable device to enter a low-power mode; determining whether the first sensing signal is larger than a second threshold when the display panel has entered the low-power mode; and when it is determined that the first sensing signal is larger than the second threshold and the display panel has entered the low-power mode, controlling the display panel to enter a normal display mode from the low-power mode.

### BACKGROUND OF THE INVENTION

Field of the Invention

The invention relates to a portable device, and, in particular, to a portable device equipped with a transflective or reflective display and associated control method capable of utilizing ambient light sensors and/or motion sensors to reduce power consumption of the display of the portable device.

Description of the Related Art

With advances in technology, a transflective display or a reflective display has been used in a portable device for saving power. These kinds of displays can reflect environment light, such as daylight, as its backlight. When the environment light is sufficient, it does not cost any power for the backlight.

Generally, the transflective display or the reflective display is usually implemented by a liquid-crystal display (LCD), or an organic light-emitting diode (OLED) display due to their superior display performance. However, an LCD or OLED display needs power to refresh the display content, and it may cost much power and reduce the battery life. Accordingly, there is demand for a portable device to solve the aforementioned issue.

### BRIEF SUMMARY OF THE INVENTION

A detailed description is given in the following embodiments with reference to the accompanying drawings.

A portable device is provided. The portable device includes an ambient light sensor; and a control module. The ambient light sensor is configured to detect ambient light around the portable device to generate first sensing signal. The control module is configured to generate display content to be displayed on the display panel, and gather the first sensing signal from the ambient light sensor. When the control module determines the first sensing signal is smaller than the first threshold, the control module controls the display panel to enter a sleep mode. When the control module determines the first sensing signal is larger than a second threshold and the display panel has entered the sleep mode, the control module controls the display panel to enter a normal display mode from the sleep mode.

A portable device is provided. The portable device includes: an ambient light sensor, a control module, and an application module. The ambient light sensor is configured to detect ambient light around the portable device to generate a first sensing signal. The control module is configured to gather the first sensing signal from the ambient light sensor. The application module is for executing an application to generate display content to be displayed on a display panel. When the control module determines the first sensing signal is smaller than a first threshold, the control module controls the display panel to enter a sleep mode. When the control module determines the first sensing signal is larger than a second threshold and the display panel has entered the sleep mode, the control module controls the display panel to enter a normal display mode from the sleep mode.

A computer-implemented method for use in a portable device is provided. The method includes the steps of: utilizing an ambient light sensor of the portable device to detect ambient light around the portable device to generate a first sensing signal; determining whether the first sensing signal is smaller than a first threshold; when it is determined that the first sensing signal is smaller than the first threshold, controlling a display panel of the portable device to enter a sleep mode; determining whether the first sensing signal is larger than a second threshold when the display panel has entered the sleep mode; and when it is determined that the first sensing signal is larger than the second threshold and the display panel has entered the sleep mode, controlling the display panel to enter a normal display mode from the sleep mode.

### BRIEF DESCRIPTION OF THE DRAWINGS

The invention can be more fully understood by reading the subsequent detailed description and examples with references made to the accompanying drawings, wherein:

FIG. 1 is a block diagram of a portable device in accordance with an embodiment of the invention;

FIG. 2 is a block diagram of a portable device in accordance with another embodiment of the invention; and

FIG. 3 is a state diagram of display modes of the portable device in accordance with an embodiment of the invention.

### DETAILED DESCRIPTION OF THE INVENTION

The description is made for the purpose of illustrating the general principles of the invention and should not be taken in a limiting sense. The scope of the invention is best determined by reference to the appended claims.

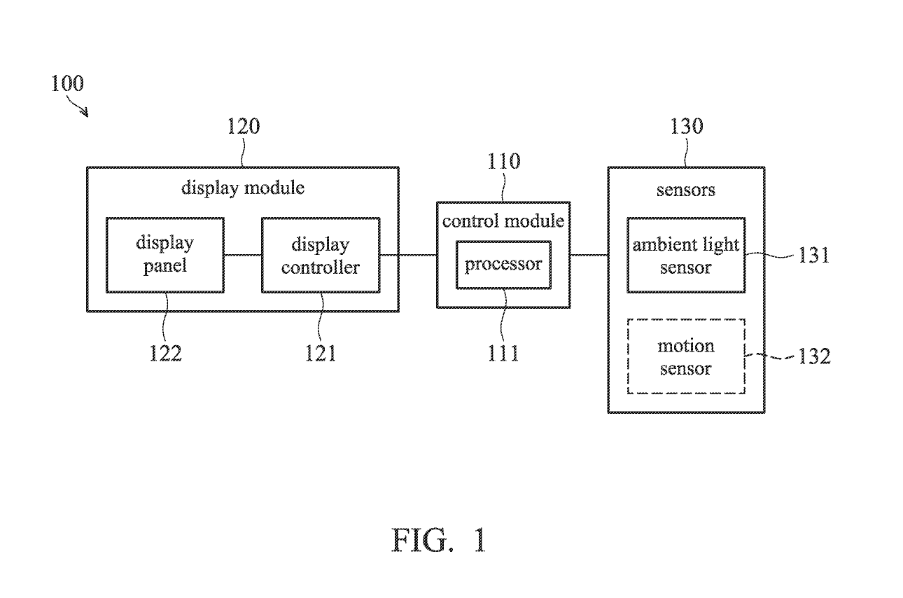

FIG. 1 is a block diagram of a portable device in accordance with an embodiment of the invention. The portable device 100 includes a control module 110, a display module 120, and one or more sensors 130. The sensors 130 may include an ambient light sensor (ALS) 131 which detects the ambient light of the environment, and optionally include a motion sensor 132 which is implemented by an accelerometer and a gyroscope. The control module 110 comprises one or more processors 111 (e.g. CPU or DSP) or microcontrollers (MCU) configured to analyze the sensing signal (e.g. sensor data) from the sensors 130, and transmit a decision signal to the display module 120. The display module 120 includes a display controller 121 and a display panel 122. The display controller 121 is configured to control the display timing and power states of the display panel 120, and the power states, for example, may be a normal display mode, a low-power display mode, a sleep mode, or a shutdown mode, based on the decision signal from the control module 110. For example, the control module 110 is configured to execute a program code or an application to output display content to the display module 120. Alternatively, the control module 110 and the sensors 130 can be integrated into a sensor hub. In some embodiments, the display controller 121 can be integrated into the control module 110.

The display panel 122 may be a transmissive display panel or a reflective display panel implemented by LCD or OLED technologies. The transflective display panel is a display panel that reflects and transmits light (i.e. transflective =transmissive & reflective). Under bright illumination (e.g. when exposed to daylight), the transflective display panel acts mainly as a reflective display panel with the contrast being constant with illuminance. An auxiliary transmissive backlight is needed in the transflective display panel only in dim and dark ambient situations. Alternatively, the display panel 122 comprises a touch detection module for detecting touch events on the surface of the display panel 122. In an embodiment, the portable device 100 is a wearable device that can be wearable on a user's wrist, upper arm, and/or leg, or may be attached to the user's clothing, and may have the functions of a wristwatch, a wearable display, and/or a portable media player.

In an embodiment, a user may become less sensitive to the images displayed on the display panel 122 of the portable device 100 in a dim or dark environment, especially on a transflective display panel or a reflective display panel. Thus, a low-power mechanism can be applied on the display panel 122 to reduce power consumption. The control module 110 determines whether the sensing signal (e.g. the amount of ambient light) from the ambient light sensor is smaller than a first threshold. When the control module 110 determines that the sensing signal from the ambient light sensor is smaller than a first threshold, the control module 110 controls the display panel 122 to enter a sleep mode to reduce power consumption, or informs the display controller 121 to control the display panel 122 to enter the sleep mode . When the display panel 122 has entered the sleep mode, the control module 110 further determines whether the sensing signal from the ambient light sensor is larger than a second threshold. When the control module 110 determines that the sensing signal from the ambient light sensor is larger than the second threshold, the control module 110 controls the display panel 122 to enter the normal display mode, or informs the controller 121 of the display module 120 to control the display panel 122 to enter the normal display mode. Alternatively, the user may manually awaken the display panel 122 by some specific operations, such as pressing hardware buttons or software icons of the portable device 100, or performing a gesture on the display panel 122, but the invention is not limited thereto.

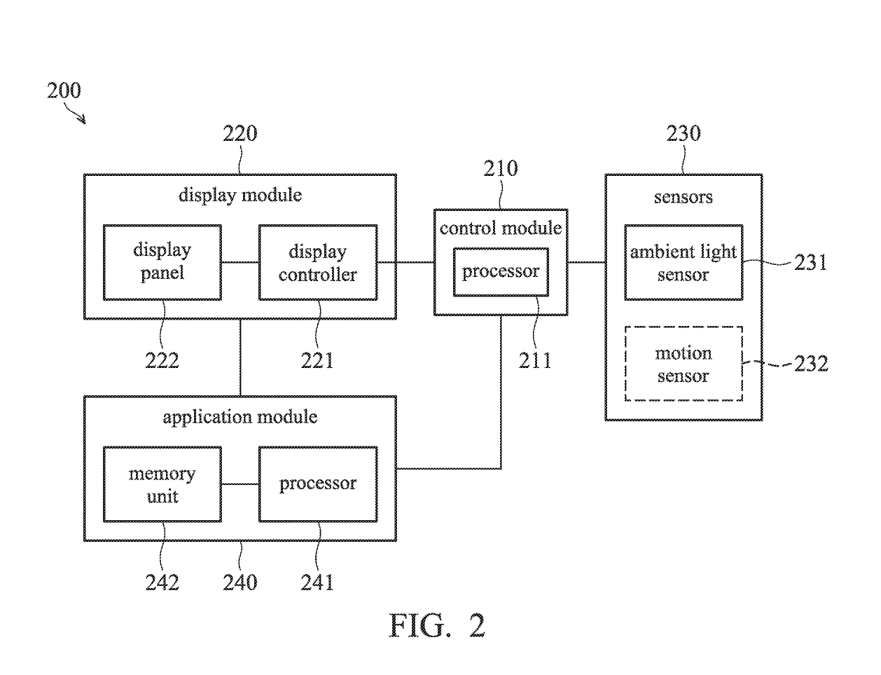

FIG. 2 is a block diagram of a portable device in accordance with another embodiment of the invention. The portable device 200 includes a control module 210, a display module 220, sensors 230, and an application module 240. The sensors 230 may include an ambient light sensor (ALS) which detects the ambient light of the environment, and optionally include a motion sensor such as an accelerometer. The control module 210 comprises one or more processors 211 configured to analyze the sensing signal (e.g. sensor data) from the sensors 230, and transmit a decision signal to the display module 220. Depending on the desired configuration, the processors 211 can be of any type, including a microprocessor, a microcontroller, or a digital signal processor. The display module 220 includes a display controller 221 and a display panel 222. The display controller 221 is configured to control the display timing and the power mode of the display panel 220, such as a normal mode, or a low-power mode, based on the decision signal from the control module 210. The application module 240 is configured to generate the display content and setup the display mode of the display panel 222 of the display module 220, such as a normal display mode or a low-power display mode. The display panel 222 may be a transflective display panel or a reflective display panel implemented by LCD or OLED technology. In some embodiments, the display controller 221 can be integrated into the control module 210.

The application module 240 provides an environment for executing applications that utilize the display panel 222 to display content of the applications. For example, the application module 240 may comprise a processor 241, and a memory unit 242. For example, the processor 241 may be a central processing unit (CPU) or a digital signal processor (DSP). Depending on the desired configuration, the memory unit 242 can be of any type, including volatile memory (such as RAM) and non-volatile memory (such as ROM, flash memory). The memory unit 242 can include an operating system, one or more applications, and program data. The processor 241 may execute an application stored in the memory unit 242, and determine whether to switch the display panel 222 between a normal display mode, a low-power display mode, and a sleep mode. For example, the executed application may use different color depth in the normal display mode and the low-power display mode, such as using 8-bit color depth in the normal display mode and 1-bit color depth in the low-power display mode. In addition, the executed application may apply different user interfaces in the normal display mode and the low-power display mode, such as applying simple icons or a lower resolution in the low-power display mode.

In an embodiment, the sensors 230 include both the ambient light sensor 231 and the motion sensor 232. The control module 210 determines whether the first sensing signal, e.g. amount of ambient light, from the ambient light sensor 231 is smaller than a first threshold and the second sensing signal, e.g. amount of motion, from the motion sensor 232 is smaller than a second threshold. When the control module 210 determines that the first sensing signal from the ambient light sensor is smaller than a first threshold and the second sensing signal from the motion sensor 232 is smaller than a second threshold, the control module 210 controls the display panel 222 to enter the sleep mode to reduce power consumption. When the display panel 222 has entered the sleep mode, the control module 210 further determines whether the first sensing signal from the ambient light sensor 231 is larger than a third threshold or the second sensing signal is larger than a fourth threshold. When the control module 210 determines that the first sensing signal from the ambient light sensor 231 is larger than the third threshold or the second sensing signal is larger than the fourth threshold, the control module 210 awakens the display panel 222 to enter the normal display mode from the sleep mode.

For example, the control module 210 controls the display panel 222 to enter the sleep mode when the portable device 100 is in a dim or dark environment (i.e. the ambient light is weak) and is likely stationary or slightly moving (i.e. a small amount of motion). When the user is wearing the portable device and entering a bright environment, the control module 210 awakens the display panel 222 to enter the normal mode from the sleep mode. Alternatively, when the portable device is moving strenuously (e.g. a large amount of motion), the control module 210 also awakens the display panel 222 to enter the normal mode from the sleep mode. In addition, the user may manually awaken the portable device to enter the normal mode from the sleep mode by performing specific operations, such as pressing a hardware button, a software icon, a touch or a gesture on the portable device 200, but the invention is not limited thereto.

In one embodiment, the portable device 200 is a wearable device. For example, the portable device 200 may be a smart watch or a smart wristband, and the portable device 200 may further include a strap, a wristband, or a bracelet (not shown in FIG. 2). It should be noted that the portable device 200 may be in any form of wearable accessories equipped with a transflective display panel or a reflective display panel, and the invention is not limited to the aforementioned portable devices. For example, the portable device 200 can be wearable on a user's wrist, upper arm, and/or leg, or may be attached to the user's clothing, and may have the functions of a wristwatch, a wearable display, and/or a portable media player.

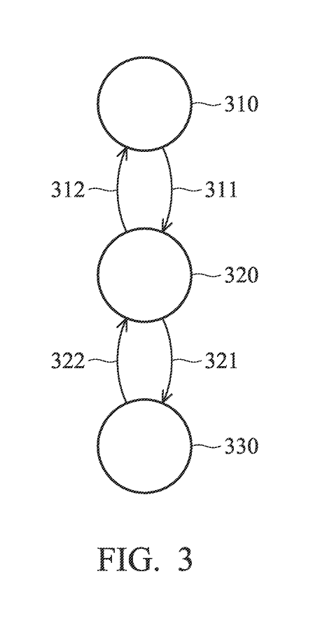

FIG. 3 is a state diagram of display modes of the portable device in accordance with an embodiment of the invention. In state 310, the display panel 222 is in a normal display mode. In branch 311, when the display controller 221 and the application module 240 are informed to signal the display panel 222 to enter the low-power display mode (e.g. in a dim environment) from the normal display mode, the application module 240 may change the display content to be displayed on the display panel 222 in the low-power display mode. In state 320, the display panel 222 is in the low-power display mode. For example, since the user becomes less sensitive to the displayed images on the display panel 222 in a dim environment, the application module 240 may use 1-bit color depth in the red, green, and blue color channels to reduce the updating and/or refreshing power of the display panel 222, so that the power consumption can be significantly reduced in the low-power display mode. For example, the refresh rate of display panel 222 can be reduced to 30 Hz from 60 Hz, and the resolution of the display panel can be reduced to the quarter HD resolution (e.g. 960×540) from a full HD resolution (e.g. 1920×1080). For one having ordinary skill, it will be appreciated that the invention is not limited to the aforementioned refresh rate and resolution.

In branch 312, when the display panel 222 is in the low-power display mode and the portable device 200 has entered a bright environment, the display controller controls the display panel 222 to enter the normal display mode from the low-power display mode (branch 312). In state 330, the display panel 222 is in the sleep mode. In branch 321, when the portable device 200 is in a dark environment, the display controller 221 is informed to control the display panel 222 to enter the sleep mode, and the display controller 221 may control the display panel 222 to enter the sleep mode from the low-power display mode. Contrarily, when the display panel 222 is in the sleep mode and the portable device 200 has entered a dim environment, the display controller 221 may control the display panel to enter the low-power display mode from the sleep mode (branch 322).

For example, during the transition between the normal display mode (state 310) and the sleep mode (state 330), the display controller 221 and the application module 240 may control the display panel 222 to enter the low-power display mode (state 320). In the low-power display mode, the application module 240 further adaptively controls the display content to fit the low-power display mode, respectively. The details can be referred to in the aforementioned embodiments. Furthermore, the transition of states in FIG. 3 can be simplified to state 310 and state 320. State 320 indicates that the display panel 222 is in a low-power mode, where the low-power mode indicates a low-power display mode, a sleep mode, or a power down mode.

While the invention has been described by way of example and in terms of the preferred embodiments, it is to be understood that the invention is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A portable device, comprising
an ambient light sensor, configured to detect ambient light around the portable device to generate a first sensing signal; and
a control module, configured to generate display content to be displayed on a display panel, and gather the first sensing signal from the ambient light sensor,
wherein the control module controls the display panel to enter a low-power mode in response to the first sensing signal.

2. The portable device as claimed in claim 1, further comprising: a display module, wherein the display module comprises a display controller and the display panel.

3. The portable device as claimed in claim 1, wherein the control module controls the display panel to enter the low-power mode when the control module determines that a first condition occurs, and the control module controls the display panel to enter a normal display mode from the sleep mode, wherein the first condition indicates that the first sensing signal is smaller than a first threshold and/or a first event is detected.

4. The portable device as claimed in claim 3, wherein when the control module determines that a second condition occurs and the display panel has entered the low-power mode, the control module controls the display panel to enter the normal display mode from the low-power mode.

5. The portable device as claimed in claim 4, wherein the second condition indicates that the first sensing signal is larger than a second threshold and/or a second

6. The portable device as claimed in claim 1, wherein the display panel is a transflective display panel or a reflective display panel.

7. The portable device as claimed in claim 1, further comprising:
a motion sensor, for detecting an amount of motion of the portable device to generate a second sensing signal.

8. The portable device as claimed in claim 7, wherein the control module further determines whether a first condition occurs and whether a second condition occurs,
wherein when the control module determines that the first condition occurs and the second condition occurs, the control module controls the display panel to enter the low-power mode.

9. The portable device as claimed in claim 4, wherein the control module further determines whether a third condition occurs and whether a fourth condition occurs, wherein when the control module determines that both the third and fourth conditions occur, the control module awakens the display panel to the normal display mode from the low-power mode.

10. A portable device, comprising:
an ambient light sensor, configured to detect ambient light around the portable device to generate a first sensing signal;
a control module, configured to gather the first sensing signal from the ambient light sensor; and
an application module, for executing an application to generate display content to be displayed on a display panel,
wherein when the control module determines the first sensing signal is smaller than a first threshold, the control module controls the display panel to enter a low-power mode,
wherein when the control module determines the first sensing signal is larger than a second threshold and the display panel has entered the low-power mode, the control module controls the display panel to enter a normal display mode from the low-power mode.

11. The portable device as claimed in claim 10, wherein the display panel is a transflective display panel or a reflective display panel.

12. The portable device as claimed in claim 10, further comprising: a display module, wherein the display module comprises a display controller and the display panel.

13. The portable device as claimed in claim 10, further comprising:
a motion sensor, for detecting an amount of motion of the portable device to generate a second sensing signal,
wherein the control module further determines whether the first sensing signal is smaller than the first threshold and whether the second sensing signal is smaller than a third threshold,
wherein when the control module determines that the first sensing signal is smaller than the first threshold and the second sensing signal is smaller than a third threshold, the control module controls the display panel to enter the sleep mode.

14. The portable device as claimed in claim 10, wherein the display controller further controls the display panel to enter a low-power display mode during the transition between the normal display mode and the sleep mode.

15. The portable device as claimed in claim 14, wherein when the application module is informed that the display panel is to enter the low-power display mode, the application module uses 1-bit color depth in red, green, and blue color channels of the display content.

16. The portable device as claimed in claim 15, wherein when the application module is informed that the display panel is to enter the low-power display mode, the application module uses a lower resolution for the display content.

17. A computer-implemented method for use in a portable device, comprising:
utilizing an ambient light sensor of the portable device to detect ambient light around the portable device to generate a first sensing signal;
determining whether the first sensing signal is smaller than a first threshold;
when it is determined that the first sensing signal is smaller than the first threshold, controlling a display panel of the portable device to enter a sleep mode;
determining whether the first sensing signal is larger than a second threshold when the display panel has entered the sleep mode;
when it is determined that the first sensing signal is larger than the second threshold and the display panel has entered the sleep mode, controlling the display panel to enter a normal display mode from the sleep mode.

18. The method as claimed in claim 17, wherein the display panel is a transflective display panel or a reflective display panel.

19. The method as claimed in claim 17, further comprising:
utilizing a motion sensor of the portable device to detect an amount of motion of the portable device to generate;
determines whether the first sensing signal is smaller than the first threshold and whether the sensing signal data is smaller than a third threshold;
when it is determined that the first sensing signal is smaller than the first threshold and the second sensing signal is smaller than a third threshold, controlling the display panel to enter the sleep mode.

20. The method as claimed in claim 19, further comprising:
determining whether the first sensing signal is larger than the second threshold and whether the second sensing signal is larger than a fourth threshold;
when it is determined that the first sensing signal is larger than the second threshold and the second sensing signal is larger than the fourth threshold, awakening the display panel to the normal display mode from the sleep mode.

21. The method as claimed in claim 17, further comprising:
controlling the display panel to enter a low-power display mode during the transition between the normal display mode and the sleep mode.

22. The method as claimed in claim 21, further comprising:
applying 1-bit color depth in red, green, and blue color channels of display content displayed on the display panel when the display panel has entered the low-power display mode.

23. The method as claimed in claim 21, further comprising:
applying a lower resolution for display content displayed on the display panel when the display panel has entered the low-power display mode.
